(19) United States
(12) Patent Application Publication
(10) Pub. No.: US 2013/0228346 A1
(43) Pub. Date: Sep. 5, 2013

(54) OIL-COOLED OIL TANK

(71) Applicant: PARKER-HANNIFIN CORPORATION, Cleveland, OH (US)

(72) Inventor: Richard E. Scott, Naples, FL (US)

(73) Assignee: Parker-Hannifin Corporation, Cleveland, OH (US)

(21) Appl. No.: 13/782,255

(22) Filed: Mar. 1, 2013

Related U.S. Application Data
(60) Provisional application No. 61/605,963, filed on Mar. 2, 2012.

(51) Int. Cl. A62C 2/00

(52) U.S. Cl. CPC A62C 2/00
USPC 169/45; 169/54

(57) ABSTRACT

A tank assembly for containing liquid with increased heat resistance includes a lightweight container for liquid having an inlet and an outlet, and a spray assembly. The spray assembly includes means for spraying a liquid, also called a spray device, inside the container that is fluidly connected to the inlet. The spray device has an orifice located so as to direct liquid received from the inlet against an inside surface of the container walls. The liquid forms a sheet that flows down the walls of the container to a pool of liquid to reduce the temperature of the walls of the container above the pool.

### RELATED APPLICATIONS

This application claims the benefit of U.S. Provisional Application No. 61/605,963 filed Mar. 2, 2012, which is hereby incorporated herein by reference.

### FIELD OF THE INVENTION

The present invention is directed to an oil tank for an aircraft, and more particularly to a system and method for increasing the fire resistance of such a oil tank.

### BACKGROUND OF THE INVENTION

An aircraft includes a lubrication system that circulates oil to lubricate the engine. The oil circulation system includes a tank that acts as the reservoir for the lubricating oil. Aircraft regulating agencies require most commercial aircraft to have oil tanks that can withstand direct impingement of flames during an engine fire for a specified time period without leaking any oil.

Such tanks often are made of stainless steel. Typical added fire-protection systems employ a blanket of fire-resistant insulation (commonly referred to as a fire blanket) wrapped around the tank or a fire-proof coating (sometimes referred to as a fire-resistant or heat-resistant coating) applied to the tank.

### SUMMARY OF THE INVENTION

The present invention provides an aluminum or other lightweight tank that provides significant weight savings over the standard stainless steel oil tanks. Besides adding weight, fire blankets and fire-resistant coatings may have limited durability. To provide the same or better fire resistance, the tank provided by the present invention includes means for spraying oil against the inside walls of the tank as the oil enters the tank. This oil forms a sheet that flows down the walls of the tank to minimize the temperature of the walls of the tank. Thus the invention allows the use of an aluminum tank without the need for a blanket of heat-resistant insulation or a fire-resistant coating. In addition, spraying the oil against the side walls of the tank may improve air-oil separation.

More particularly, the present invention provides a tank assembly for containing liquid with increased heat resistance. The tank assembly includes a container for liquid having an inlet and an outlet, and a spray assembly. The spray assembly includes a spray device inside the container that is fluidly connected to the inlet. The spray device has an orifice located so as to direct liquid received from the inlet against an inside surface of the container.

In an exemplary tank assembly, the spray device is a spray bar having multiple orifices, and the spray bar is located toward an upper region of the container. The orifices are oriented to direct a stream of liquid against an upper portion of the inside surface of the container.

The tank assembly also can include an air/liquid separator fluidly interconnected between the inlet and the spray device, for separating air from the liquid.

An exemplary container is made of aluminum, and an exemplary liquid is oil.

The present invention also provides a method of minimizing the temperature of a container for a liquid. The method includes the step of directing a stream of liquid against an upper portion of an inside surface of the container to form a sheet of liquid on the inside surface.

Further features of the invention will become apparent from the following detailed description when considered in conjunction with the drawings.

### BRIEF DESCRIPTION OF THE DRAWINGS

FIG. 1 is a schematic diagram of a simple lubricating system with an oil tank provided in accordance with the present invention.

FIG. 2 is a cross-sectional elevation view of the oil tank of FIG. 1, as seen along lines 2-2 of FIG. 1.

FIG. 3 is a cross-sectional top view of the oil tank of FIG. 2.

FIG. 4 is an cross-sectional top view of an alternative oil tank provided in accordance with the present invention.

### DETAILED DESCRIPTION

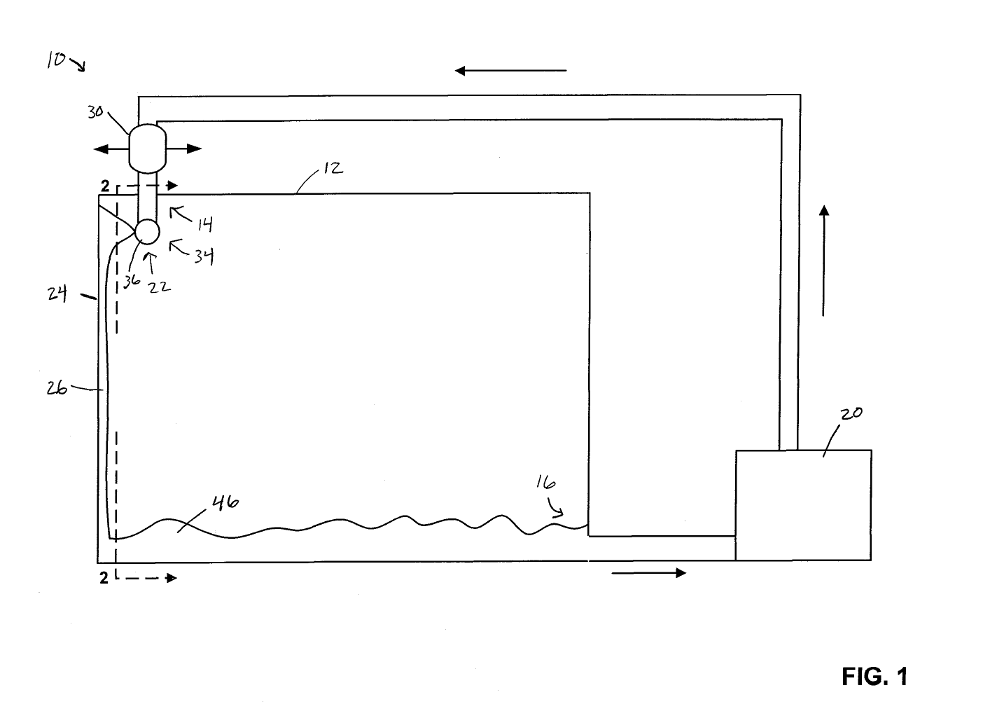

Referring now to the drawings, and initially FIG. 1, the present invention provides an improved tank assembly 10 for containing liquid for use on an aircraft. The tank assembly 10, includes a lightweight container 12 (also referred to as a tank) for liquid, such as oil, that is provided with features that make the container 12 more resistant to damage from heat, such as the heat of a fire. The invention is not limited to containers for oil, however. While oil is an exemplary liquid for use in the tank, other liquids can be used with the principles of the invention. So while the invention will be described with reference to an oil tank, references to oil include alternative liquids, such as hydraulic liquid, liquid fuel, water, etc.

The container 12 includes an inlet 14, and an outlet 16. The tank assembly 10 further includes a pump 20 fluidly coupled to at least one of the inlet 14 and the outlet 16 to pump oil into or out of the container 12. The container 12 preferably is made of aluminum or other lightweight material, including heat-sensitive materials. Aluminum is preferred over stainless steel for its lighter weight, but aluminum is not as heat-resistant. Besides adding weight, fire blankets and fire-resistant coatings can have limited durability, previously being necessary to ensure the required heat resistance for many lightweight containers.

To provide the same or better heat resistance, the container 12 provided by the present invention includes means 22 for spraying oil against an upper portion of the inside surface of side walls 24 of the container 12 as the oil enters the container 12. This oil forms a sheet 26 that flows down an inside surface of the walls 24 of the container 12 to minimize the temperature of the walls 24, and thereby increases the container's heat- and fire-resistance. To facilitate the description, the illustrated embodiment only sprays oil against one wall 24 of the illustrated container 12, however the spray means 22 can be modified to spray more than one wall 24, or more than one spray means 22 can be provided to spray respective ones of multiple walls 24. Accordingly, the present invention provides a lightweight container 12 for liquid, such as oil, without the need for a fire blanket or a fire-resistant coating, thereby further reducing the weight of the tank assembly 10. As another advantage, spraying the oil against the side walls 24 of the container 12 may improve air-oil separation.

To facilitate separation of air and other gases from the liquid, the illustrated tank assembly 10 also includes an air-liquid separator 30 between the pump 20 and the spray means 22 to remove air or other gases from the liquid oil before the oil is sprayed on the inside surfaces of the walls 24 of the container 12. An air-oil separator is not affected by gravity; therefore, it can be placed conveniently to feed the spray means 22, either inside or outside of the container 12, preferably near the container inlet 14. Removing gases from the oil improves the heat-transfer from the container walls 24 to the oil.

The oil tank 12 generally is only partially filled with oil. In the required fire test on a conventional tank constructed of aluminum instead of stainless steel, the portions of the container walls that were above the oil level were destroyed. The portions of the tank walls that were below the oil level survived. The pool of oil removed heat from the inside surface of the tank, increasing the tank's resistance to the heat of the fire.

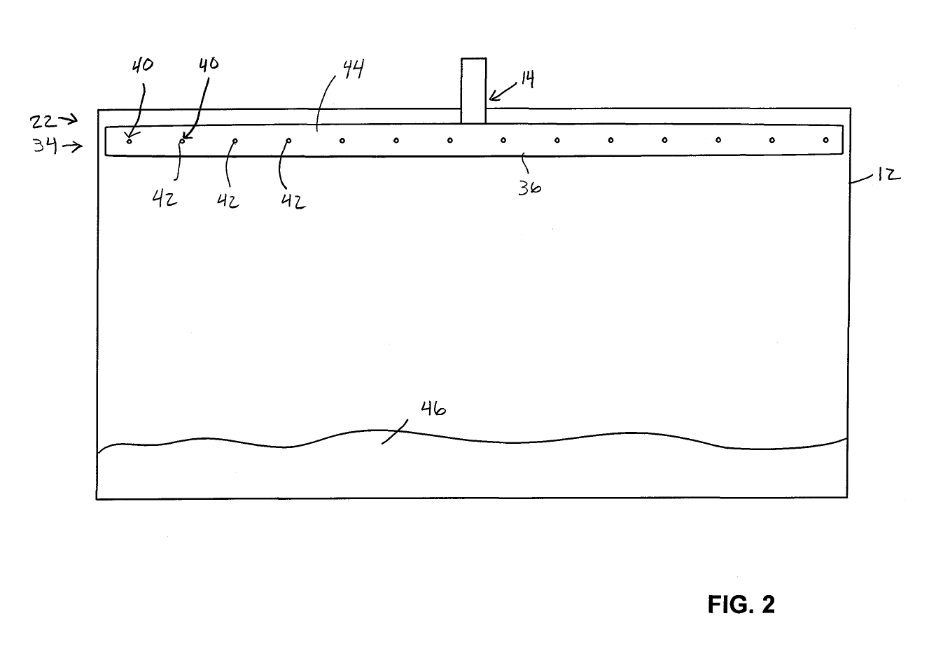

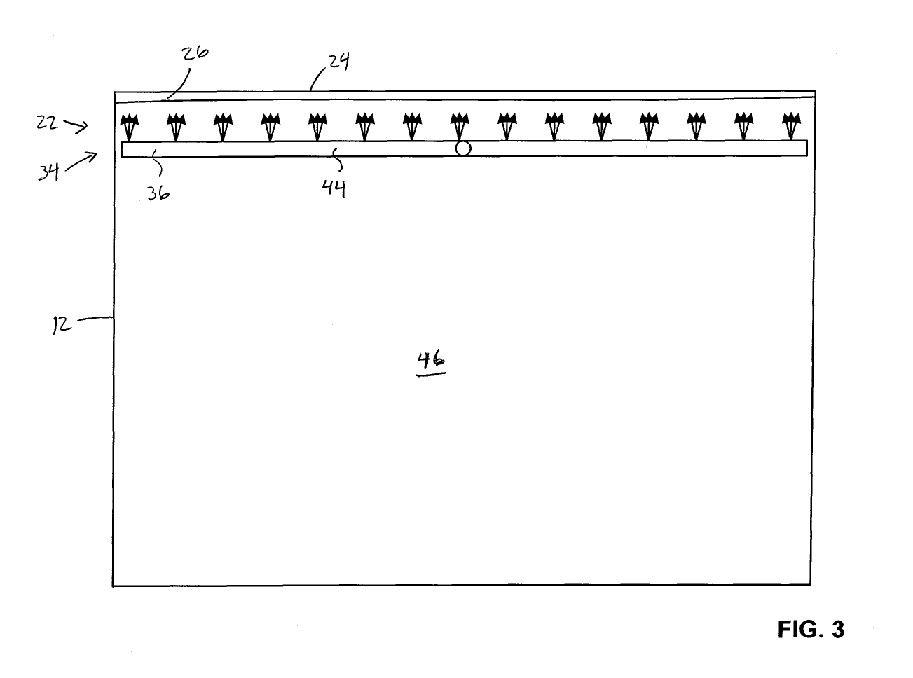

Referring now to FIGS. 1-3, an exemplary spray means 22 within the tank 12 includes a spray assembly 34 having a conduit 36 and a spray device 40 fluidly connected to the inlet 14. The spray device 40 is inside the container 12. Specifically, the spray device 40 has an orifice 32 positioned to direct fluid received from the inlet 14 against an inside surface of the container walls 24. In the illustrated embodiment, the spray device 40 includes a spray bar 44 having multiple orifices 42 spaced along its length. The spray bar 44 is located toward an upper region of the container 12, and the orifices 42 are oriented to direct a stream of liquid against an upper portion of the inside surface of the container walls 24. This forms a sheet 26 of oil that moves down the walls 24, removing heat from the walls 24 to a pool 46 of oil in a lower portion of the container 12. Tests have shown that this arrangement increases the survivability of an aluminum container sufficiently to pass the required fire test.

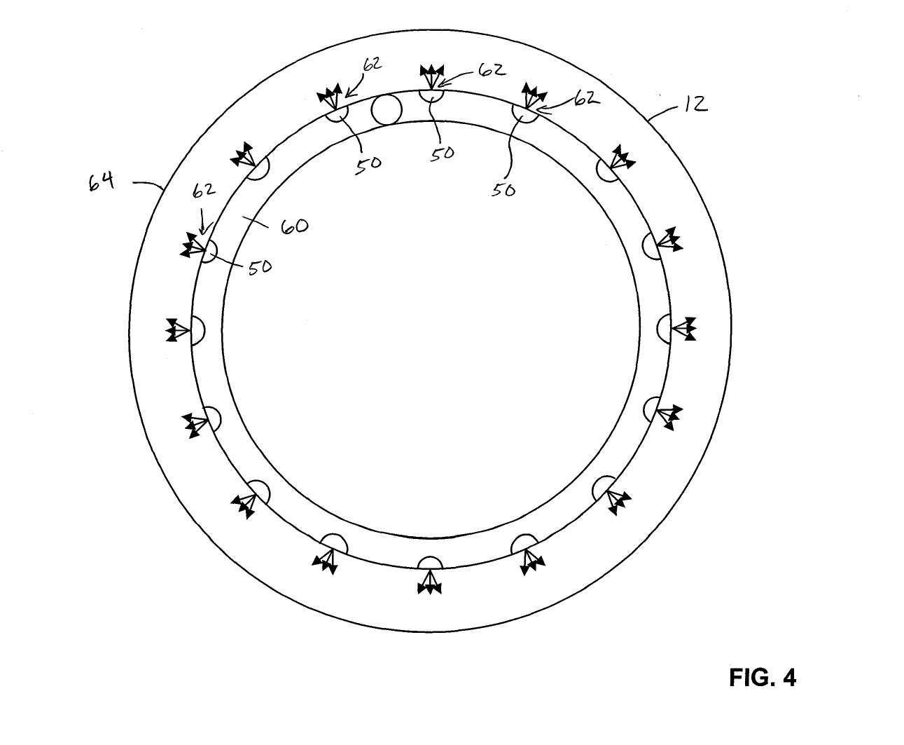

The orifices 42 can be formed by holes or slits in the spray bar 44, or can be formed by spray nozzles 50 (FIG. 4) mounted to the spray bar 44. The orifices 42 preferably are spaced apart to direct streams of oil to one or more sides of the container 12. The orifices 42 preferably direct a stream of liquid, more preferably a continuous stream of liquid, against the walls 24 of the container 12, in contrast to creating a mist.

In FIGS. 1-3, the spray means 22 includes a linear spray bar 44 with closed ends and multiple orifices 42 spaced along the length of the spray bar 44. This is an exemplary embodiment, however, the invention is not limited to such a spray means 22. Additional spray bars 44 may be provided to protect other walls 24 of the container 12, as mentioned above. Additionally, while the illustrated embodiment supplies oil from the inlet 14 to the spray bar 44 at a central location on the spray bar 44, the oil may enter the spray bar 44 at or closer to one end of the spray bar 44.

A further alternative spray means 22 is shown in FIG. 4, where the spray means 22 is provided by a spray bar 60 that has a circular ring-shape with circumferentially-spaced orifices 62 in respective nozzles 50 to direct oil against the side walls 64. As is apparent from FIG. 4, the container 12 itself need not be rectangular, but can have a different geometric shape, such as cylindrical, as shown in FIG. 4.

An exemplary method for minimizing the temperature of the container on an aircraft, includes the steps of first, and optionally, separating gases (such as air) from the liquid (typically oil) to be stored in the container. Air-oil separators are not 100% effective at removing all of the gases from the oil, but removing as much of the gases as possible does increase the heat transfer capabilities of the oil. Then, whether or not gases are removed from the liquid, instead of sending the oil directly into the pool of oil in the container, the method includes directing a stream of liquid against an upper portion of an inside surface of the container to form a sheet of liquid on the inside surface. This sheet of liquid will flow down the inside surface of the container under the influence of gravity. Heat, such as from a fire, is conducted through the container walls and into the sheets of oil flowing down the walls. The oil helps to prevent the heat from damaging the container by absorbing heat from the container walls. The heated oil flows into the pool of oil in the lower portion of the container, and can be pumped through the container outlet and back into the lubrication system. The lubrication system dissipates some of the heat, returning a cooler oil to the container inlet.

The directing step can include using the tank assembly 10 described above, spraying the liquid from multiple nozzles, and directing a liquid containing oil.

In summary, the present invention provides a tank assembly 10 for containing liquid with increased heat resistance. The tank assembly 10 includes a lightweight container 12 for liquid having an inlet 14 and an outlet 16, and a spray assembly 34. The spray assembly 34 includes means 22 for spraying a liquid, also called a spray device 40, inside the container 12 that is fluidly connected to the inlet 14. The spray device 40 has an orifice 42 located so as to direct liquid received from the inlet 14 against an inside surface of the container walls 24. The liquid forms a sheet 26 that flows down the walls 24 of the container 12 to a pool of liquid 46 to reduce the temperature of the walls 24 of the container 12 above the pool 46.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A tank assembly for containing liquid, the tank assembly including:
a container for liquid having an inlet and an outlet; and
a spray assembly having a spray device inside the container that is fluidly connected to the inlet, the spray device having an orifice located so as to direct liquid received through the inlet against an inside surface of the container.

2. A tank assembly as set forth in claim 1, wherein the spray device comprises a spray bar having multiple orifices, and the spray bar being located toward an upper region of the container, the orifices being oriented to direct a stream of liquid against an upper portion of the inside surface of the container.

3. A tank assembly as set forth in claim 1, further including an air/liquid separator fluidly interconnected between the inlet and the spray device, for separating air from the liquid.

4. A tank assembly as set forth in claim 1, where the spray assembly includes a plurality of spray devices.

5. A tank assembly as set forth in claim 1, where the spray device includes a plurality of spray nozzles arranged to direct a stream of liquid against circumferentially-spaced locations on the inside surface of the container.

6. A tank assembly as set forth in claim 1, where the container includes a generally vertical side wall, and the spray device is arranged to direct a stream of liquid against an upper portion of the side wall.

7. A tank assembly as set forth in claim 1, where the container has one or more side walls, a top wall, and a bottom wall that cooperate to define an enclosed volume.

8. A tank assembly as set forth in claim 1, where the spray assembly includes a conduit connected to the inlet, and the spray device is formed by an opening in the conduit.

9. A tank assembly as set forth in claim 1, where the spray assembly includes a conduit connected to the inlet, and the spray device includes a plurality of spray nozzles arranged along a length of the conduit.

10. A tank assembly as set forth in claim 1, comprising a pump fluidly coupled to at least one of the outlet and the inlet.

11. A tank assembly as set forth in claim 10, where the pump is coupled to the inlet, and comprising an air-oil separator between the pump and the spray nozzle.

12. A tank assembly as set forth in claim 1, where the container is made of aluminum or another heat-sensitive material.

13. A tank assembly as set forth in claim 1, comprising a volume of liquid in the container, where the liquid includes oil.

14. A method of minimizing the temperature of a container for a liquid, comprising the step of:
directing a stream of liquid against an upper portion of an inside surface of the container to form a sheet of liquid on the inside surface.

15. A method as set forth in claim 14, where the directing step includes spraying the liquid from multiple nozzles.

16. A method as set forth in claim 14, comprising the step of separating air from the liquid before the directing step.

17. A method as set forth in claim 14, where the directing step includes directing a liquid containing oil.
